(19) United States
(12) Patent Application Publication
(10) Pub. No.: US 2008/0141974 A1
(43) Pub. Date: Jun. 19, 2008

(54) Rotary engine system

(76) Inventor: Paul Y. Bechtel, (US)

Correspondence Address: ROBERT A. PARSONS, 4000 N. CENTRAL AVENUE, SUITE 1220, PHOENIX, AZ, 85012, US

(21) Appl. No.: 11/998,880

(22) Filed: Nov. 30, 2007

Related U.S. Application Data
(63) Continuation-in-part of application No. 11/084,418, filed on Mar. 18, 2005, now abandoned.

(51) Int. Cl. F02B 75/00; F02B 43/10

(52) U.S. Cl. 123/243; 123/527

(57) ABSTRACT

A rotary engine includes a housing defining an enclosed spherical space, a housing chamber formed in an inner surface of the spherical space, a spherical rotor rotatably mounted within the spherical space, and a rotor chamber formed in an outer surface of the rotor. The housing chamber and the rotor chamber form a combustion chamber when in communication with each other. A fuel inlet is in communication with the combustion chamber. At least one expansion chamber is formed in the housing in communication with the enclosed spherical housing space. An exhaust system is in communication with the expansion chamber and the enclosed spherical housing space. The expansion chamber and the exhaust system are positioned to come into communication with the combustion chamber during each rotation of the rotor.

### CROSS-REFERENCE TO RELATED APPLICATION

This application is a Continuation-In-Part of U.S. patent application Ser. No. 11/084,418, entitled “ENGINE SYSTEM”, filed 18 Mar. 2005.

### FIELD OF THE INVENTION

The present invention relates generally to rotary engines and more particularly to engines including a spherical rotor.

### BACKGROUND OF THE INVENTION

Engines are typically used to convert electrical or chemical energy into energy of motion which can be used to do work. An internal combustion engine is one type of engine that converts chemical energy into energy of motion. There are several different types of internal combustion engines, such as piston and rotary engines, and each has its own advantages and disadvantages because they work in different ways. For example, piston engines provide power in response to the back and forth motion of a piston which is driven by the combustion of fuel in a cylinder. The piston is coupled to a crankshaft which rotates in response to the back and forth motion of the piston so that this motion is converted to circular motion. The crankshaft's circular motion can then be used to do work.

A rotary engine, on the other hand, provides power in response to the motion of a rotor. The rotor is moved by the combustion of fuel which causes the rotor to rotate inside a chamber. Conventional rotary engines typically include triangular shaped rotors which have three points that contact an inner surface of the chamber. The space between the rotor and the inner surface of the chamber define three separate volumes of space which are sealed from each other by the points of the triangular rotor. Each volume of space provides different functions as the rotor spins inside the chamber. For example, one volume of space provides combustion, another volume provides compression, and the third volume provides exhaustion. As the rotor rotates within the chamber, each of the three volumes of gas alternately expands and contracts. It is this expansion and contraction that draws air and fuel into the engine, compresses it, combusts it, and then expels the exhaust.

However, while prior art rotary engines may be suitable for their intended purposes, they leave much to be desired from the standpoint of efficiency and simplicity. As a result, there is a need for an improved rotary engine.

### BRIEF SUMMARY OF THE INVENTION

The objects of the invention are realized in a rotary engine that includes a housing defining an enclosed spherical space, a housing chamber formed in an inner surface of the spherical space, a spherical rotor rotatably mounted within the spherical space, and a rotor chamber formed in an outer surface of the rotor. The housing chamber and the rotor chamber form a combustion chamber when in communication with each other. A fuel inlet is in communication with the combustion chamber. At least one expansion chamber is formed in the housing in communication with the enclosed spherical housing space. An exhaust system is in communication with the expansion chamber and the enclosed spherical housing space. The expansion chamber and the exhaust system are positioned to come into communication with the combustion chamber during each rotation of the rotor.

The objects of the present invention are further realized in a specific embodiment wherein a rotary engine includes a housing defining an enclosed spherical housing space with an arcuate housing chamber formed in an inner surface of the housing within the spherical housing space. A spherical rotor is positioned within the spherical housing space and rotatably mounted therein with an outer surface of the rotor positioned adjacent the inner surface of the spherical housing space and an arcuate rotor chamber formed in the outer surface of the rotor. The housing chamber and the rotor chamber form a combustion chamber when they are in communication with each other. A fuel inlet port is positioned in communication with the housing chamber and designed and positioned to introduce a pulse of combustion gases to the combustion chamber. An ignition system is in communication with the housing chamber and connected to ignite the combustion gases in the combustion chamber subsequent to the introduction of the pulse of combustion gases. An exhaust system is in communication with the expansion chamber and the enclosed spherical housing space. The exhaust system is positioned to come into communication with the combustion chamber during each rotation of the rotor and further positioned and connected to receive expended combustion gases subsequent to the expansion chamber receiving the expanding combustion gases. At least one expansion chamber is formed in the housing in communication with the enclosed spherical housing space. The expansion chamber is positioned to come into communication with the combustion chamber during each rotation of the rotor and is further positioned to receive expanding combustion gases from the combustion chamber subsequent to ignition of the combustion gases in the combustion chamber.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a simplified front view of an engine system in accordance with the present invention;

FIG. 2 is a simplified left side view of the engine system of FIG. 1;

FIG. 3 is a simplified perspective view of the engine system in FIG. 1, portions thereof broken away and shown in section;

FIG. 4 is a simplified sectional view of the rotary engine included in the engine system of FIG. 1, taken from the line 4-4 of FIG. 1;

FIGS. 5A through 5E are partial sectional views, similar to FIG. 4, illustrating in steps the movement of the rotor;

FIG. 6 is a simplified perspective view of another embodiment of a rotary engine that includes cooling fins; and

FIG. 7 is a simplified side view of another embodiment of an engine system in accordance with the present invention.

### DETAILED DESCRIPTION OF THE INVENTION

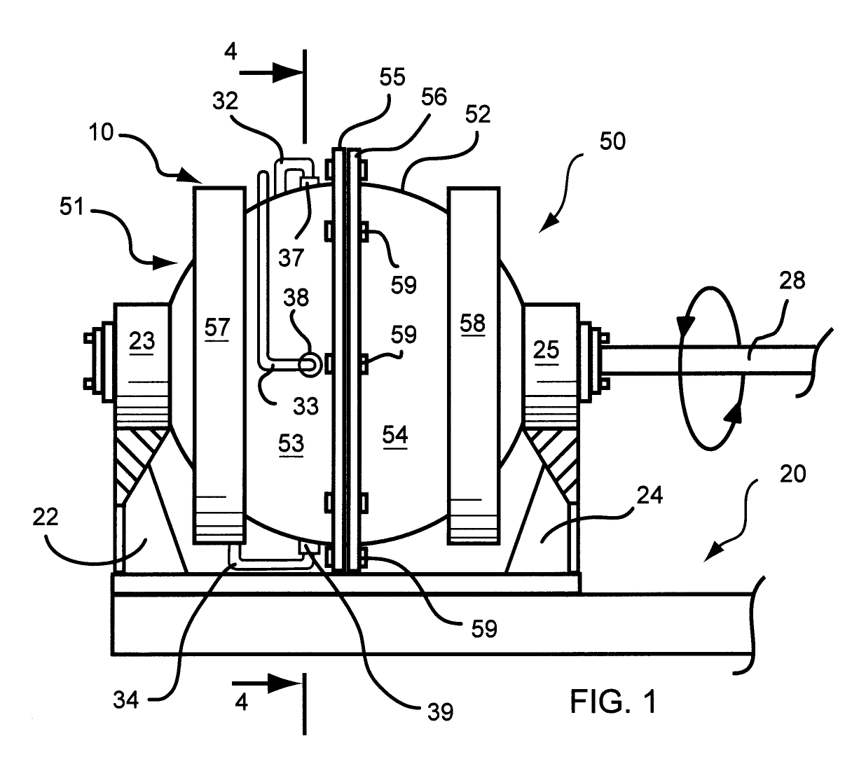

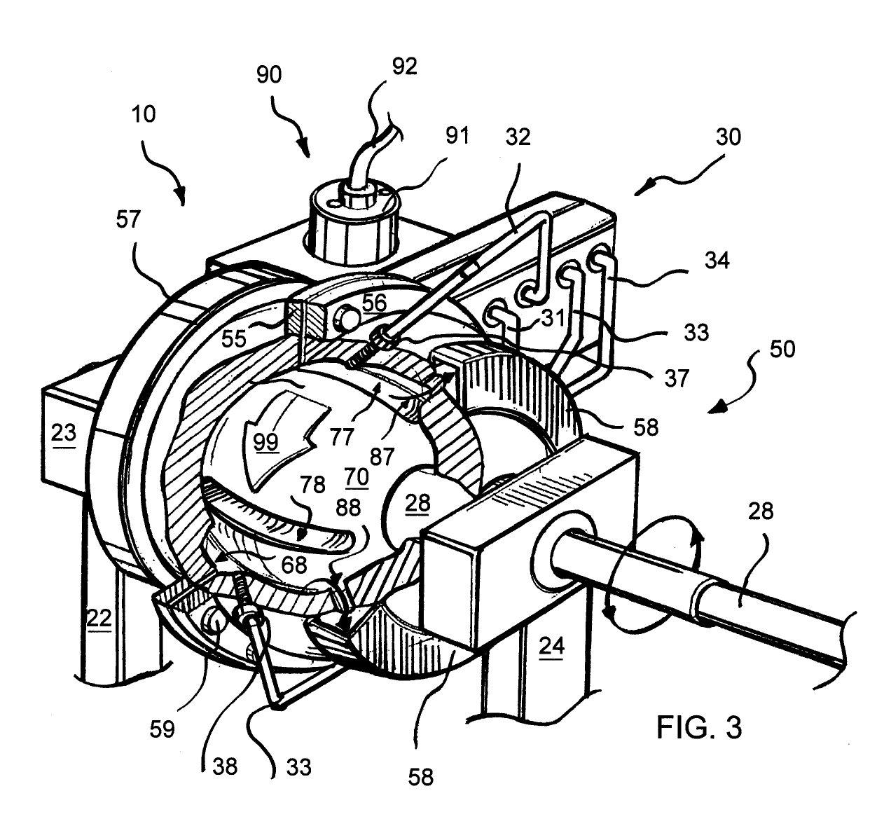

Turn now to FIGS. 1-3 which show various views of an engine system 10 in accordance with the present invention. FIGS. 1, 2, and 3 are simplified front, left side, and perspective views, respectively, of engine system 10. In FIG. 3, a portion of engine system 10 is shown in a partial cut-away view. Engine system 10 can be included in many different types of systems, such as a vehicle or a generator, to convert chemical energy to mechanical or electrical energy to do work. Engine system 10 can be fabricated using conventional materials and techniques typically used to build engines.

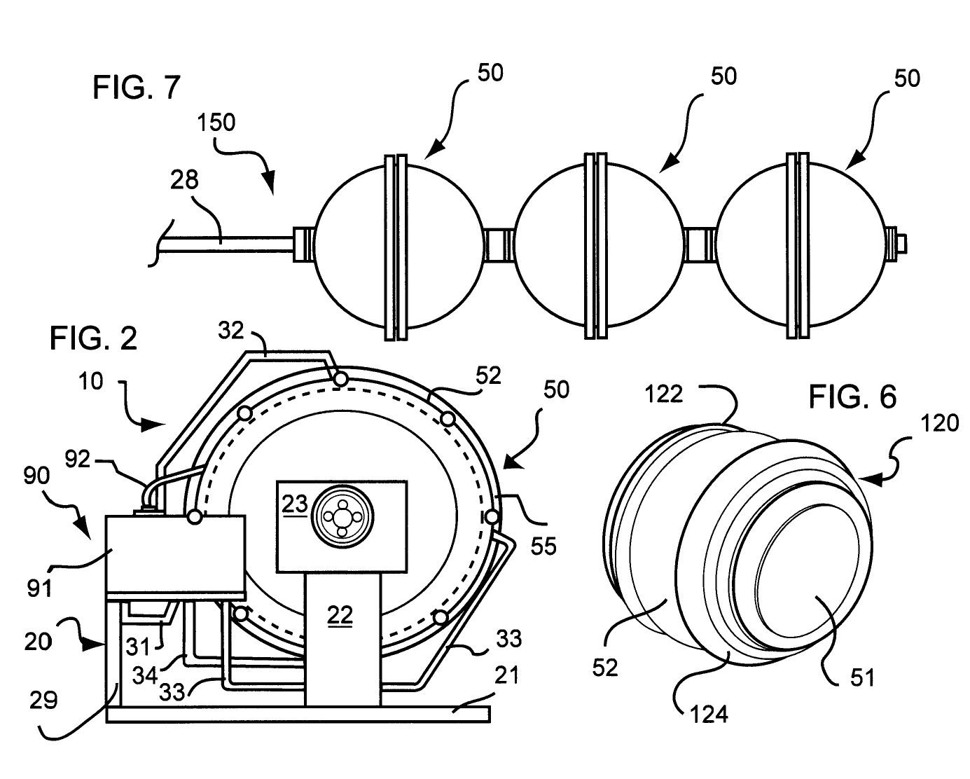

In one embodiment, engine system 10 includes a rotary engine 50 carried by a support structure 20. As will be explained in more detail presently, rotary engine 50 can be operated in a strictly gas driven mode or in a combustion mode. A gas propellant and/or fuel system 30 provides a gas propellant and/or fuel to rotary engine 50 and an ignition system 90 ignites fuel therein (See FIGS. 2-3) when rotary engine 50 is used in a combustion mode. The fuel can include many different types, but is typically hydrogen but may be a hydrocarbon or hydrogen based fuel with an oxidizing gas, such as air or oxygen. A drive shaft 28 is coupled to rotary engine 50 and rotates in response to the introduction of a propellant gas or the ignition of fuel. For vehicle systems, shaft 28 can be coupled to a drive train (not shown) in a known manner so that its rotational energy is converted to energy of motion. For generator systems, shaft 28 can be used to rotate a magnetic coil to provide electrical energy in a known manner. An exhaust system (explained in more detail presently) removes exhaust from rotary engine 50 provided by a gas propellant and/or the combustion of the fuel.

Support structure 20 can have many different configurations so that it holds rotary engine 50 and dampens vibrations caused by the rotation of the various parts included therein. In this embodiment, support structure 20 includes arms 22 and 24 which extend up from a base 21. Brackets 23 and 25 are held by arms 22 and 24, respectively, and rotary engine 50 is held between brackets 23 and 25 above base 21. In this example, drive shaft 28 extends through bracket 25 where it is coupled to rotary engine 50. Accordingly, bracket 25 includes bearings (not shown) so that drive shaft 28 is held in place and can rotate without rotating bracket 25. Support structure 20 also includes an arm 29 (FIG. 2) coupled to base 21, where arm 29 supports a fuel system 30 and ignition system 90. It should be understood that either a propellant gas and/or a combustible gas are hereinafter generically referred to as “fuel” as, for example, in the term “fuel system”.

In this embodiment, rotary engine 50 includes a housing 51 which can have many different shapes, such as simple geometric shapes, and cylindrical, but in this embodiment housing 51 is spherical. Here, housing 51 includes hemispheres 53 and 54 which have flanges 55 and 56, respectively, positioned so that they can be coupled together to form spherical housing 51. Flanges 55 and 56 can be coupled together in many different ways such as with fasteners or by welding. In this embodiment, flanges 55 and 56 are coupled together by bolts 59 which extend through flanges 55 and 56. When flanges 55 and 56 are coupled together, there is an air-tight seal between them and hemispheres 53 and 54. In this way, housing 51 bounds a housing space and defines a peripheral outer surface 52 and a peripheral inner surface 46.

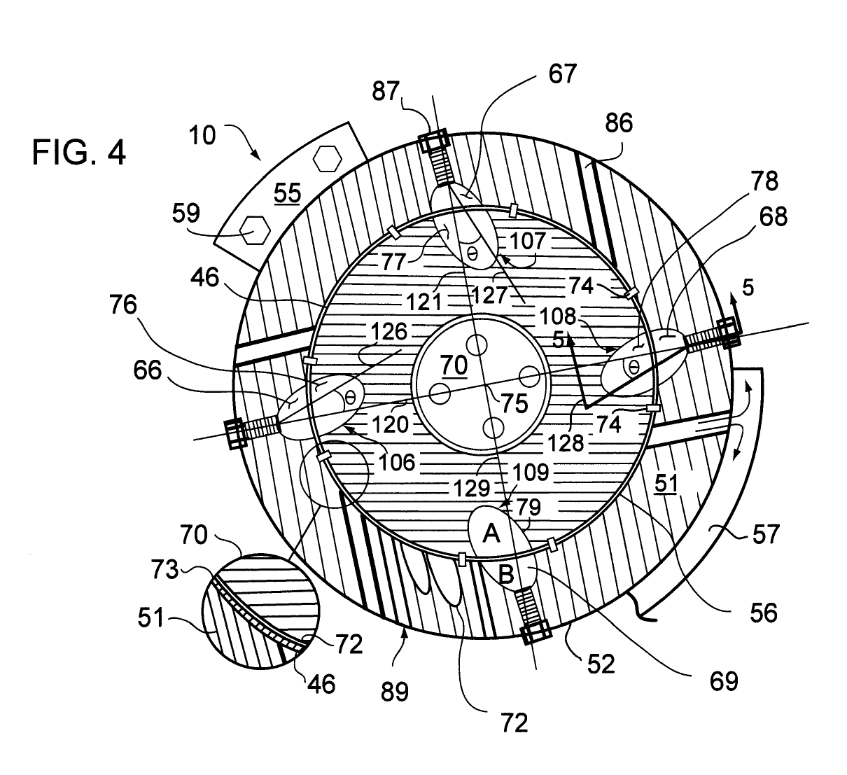

In this example, fuel system 30 and ignition system 90 are of known types and are both carried by arm 29 (FIG. 2) of support structure 20, although they can be otherwise positioned. Fuel system 30 provides fuel to rotary engine 50 through fuel lines 31-34 (FIGS. 1-3). Fuel lines 31-34 are coupled to rotary engine 50 through corresponding fuel inlets 36-39. Fuel inlets 36-39 extend through housing 51 and are coupled to corresponding housing chambers 66-69 (see FIG. 4). Ignition system 90 includes a coil 91 which provides an electrical signal through a wire 92 in a known manner to each fuel inlet 36-39, as will be discussed in more detail below. In this way, fuel inlets 36-39 inject fuel into corresponding housing chambers 66-69 and ignite it at the appropriate time (in the combustion mode), which will be described presently.

FIG. 4 is a simplified sectional view of rotary engine 50, as seen from the line 4-4, in the front view of in FIG. 1. In accordance with the invention, rotary engine 50 includes one or more housing chambers which extend into peripheral inner surface 46 of housing 51. In this particular example, rotary engine 50 includes four housing chambers 66-69 which are in communication with the housing space and open up into it. Housing chambers 66-69 can have many different shapes, but are oblong and extend lengthwise between hemispheres 53 and 54 in this example so that they are substantially perpendicular to flanges 55 and 56. Housing chambers 66-69 are positioned an equal distance apart so that housing chambers 66 and 68 are positioned opposite each other and housing chambers 67 and 69 are positioned opposite each other. In this way, housing chambers 66-69 are spaced equidistant from each adjacent housing chamber around inner surface 46 of housing 51.

In this embodiment, a rotor 70 is mounted within housing 51 so that it substantially occupies the housing space of housing 51. Rotor 70 substantially occupies the housing space so that its outer surface 72 rides within inner surface 46 of housing 51. Hence, the shape of rotor 70 is chosen to match the shape of housing 51. Rotor 70 is also mounted so that it can rotate within the housing space of housing 51. Rotor 70 is coupled to drive shaft 28 so that drive shaft 28 rotates in response to the rotation of rotor 70. In accordance with the invention, rotor 70 includes rotor chambers formed in outer surface 72 of rotor 70. In this particular example, rotary engine 50 includes four rotor chambers 76-79 which face outwardly towards housing 51. Rotor chambers 76-79 can have many different shapes, but are oblong and extend lengthwise between hemispheres 53 and 54 in this example so that they are substantially perpendicular to flanges 55 and 56. Rotor chambers 76-79 are positioned an equal distance apart so that rotor chambers 76 and 78 are positioned opposite each other and rotor chambers 77 and 79 are positioned opposite each other. In this way, rotor chambers 76-79 are spaced equidistant from each adjacent rotor chamber around outer surface 72 of rotor 70. While housing chambers 66-69 are illustrated as being nearly equal in size to rotor chambers 76-78, it will be understood from the following description of the operation that they could be substantially smaller or nearly eliminated.

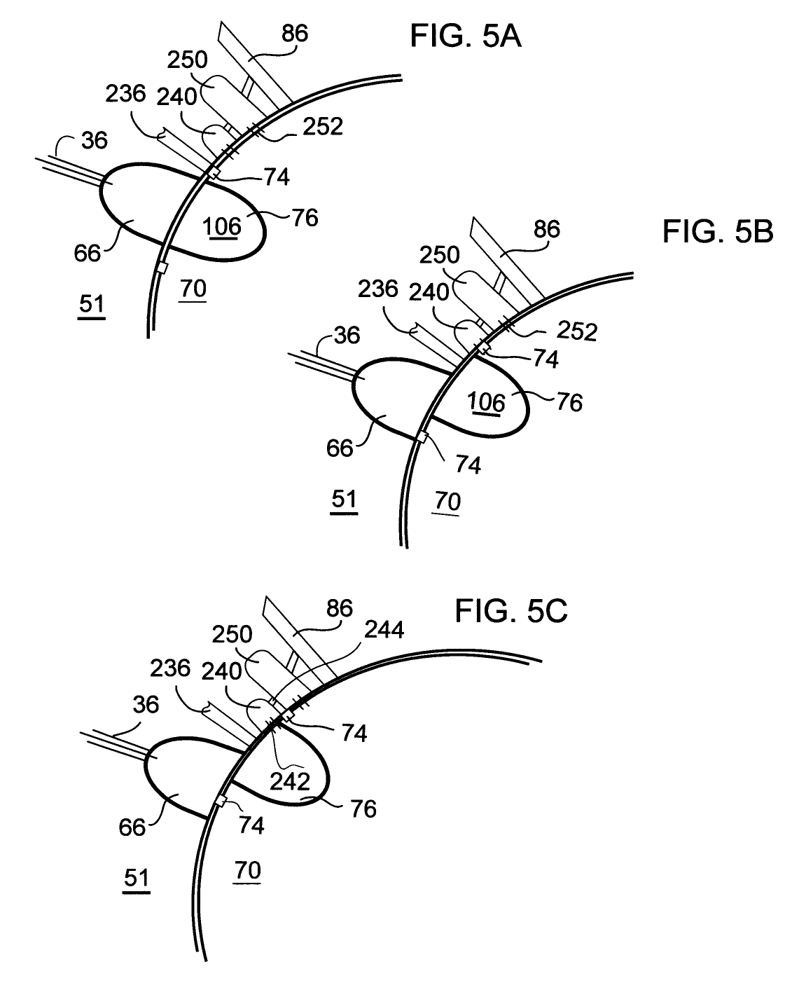

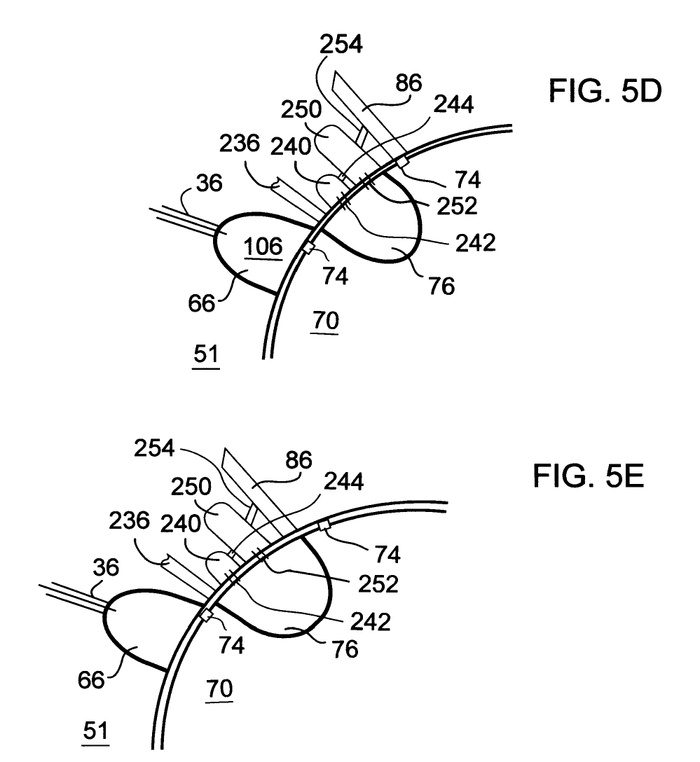

It should be noted that rotary engine 50 can include one or more rotor chambers depending on the amount of power desired and that four rotor chambers are shown here for illustrative purposes. In general, the amount of power provided by engine 50 increases with the number of rotor chambers. It should also be noted that the number of rotor chambers included in rotary engine 50 is generally the same number as housing chambers or fuel inlets. Hence, since there are four housing chambers as discussed above, there are four rotor chambers and four fuel inlets. As will be discussed in more detail below, the positioning of rotor chambers 76-79 is chosen so that they line up with corresponding housing chambers 66-69 to form combustion chambers 106-109 when fuel is injected into housing chambers 66-69. Chambers 106-109 are referred to herein as “combustion” chambers for convenience of understanding, even when engine 50 is operated in the gas driven mode. In this way, rotor chambers 76-79 and housing chambers 66-69 operate as cylinders for combustion or the reception of propellant gas, driving the rotation of rotor 70. The appropriate time of ignition occurs when rotor chambers 76-79 and housing chambers 66-69 are adjacent with each other to form combustion chambers 106-109 (as explained in conjunction with FIGS. 5 A-E). In response to the ignition of the compressed combustible gas mixture or the injection of a propellant gas, rotor 70 rotates in the direction of arrow 99, as shown in FIG. 3.

In this embodiment, rotary engine 50 also includes exhaust ports 86-89 positioned proximate to housing chamber 66-69, respectively, as shown in FIGS. 5 A-E. Exhaust ports 86-89 are carried by hemisphere 54 and extend between surfaces 52 and 46. Exhaust ports 86-89 are positioned equidistance around inner surface 46 of housing 51 so that ports 86 and 88 are opposite each other and ports 87 and 89 are opposite each other. Corresponding exhaust ports are carried by hemisphere 53. Exhaust ports 86-89 are coupled to an exhaust housing 58 and the corresponding exhaust ports carried by hemisphere 53 are coupled to an exhaust housing 57. Exhaust housings 57 and 58 extend around the outer periphery of hemispheres 53 and 54, respectively, on surface 52. An exhaust system is positioned outside housing 51 and coupled to exhaust ports 86-89, carried by hemisphere 54, and the exhaust ports (not shown) carried by hemisphere 53 through exhaust housings 57 and 58. The exhaust system can be carried by support structure 20 or it can be otherwise positioned.

In accordance with the invention, rotor chambers 76-79 are movable between several different positions relative to housing chambers 66-69, exhaust ports 86-89, and the exhaust ports carried by hemisphere 54. As best seen in FIG. 4, during a certain time interval when rotor 70 is spinning, rotor chambers 76-79 are adjacent to housing chambers 66-69 to form corresponding combustion chambers 106-109. Subsequent to that time interval, as will be explained later, rotor chambers 76-79 are in communication with exhaust ports 86-89, as shown in FIG. 4. When rotor chambers 76-79 are not adjacent to housing chambers 66-69 and exhaust ports 86-89, they face inner surface 46 of housing 51.

Here it should be understood that rotation of rotor 70 is initially produced by a starter of some type (not shown) or by the injection of fuel into combustion chambers 106-109. In the operating descriptions below, rotor 70 is already rotating and the injection of propellant gas or combustion simply provides the power to maintain rotation.

In operation, fuel system 30 provides fuel to housing chambers 66-69 through gas inlets 36-39 when rotor chambers 76-79 are adjacent to them. Housing chambers 66-69 are considered “adjacent” to rotor chambers 76-79 when they are in any communication with each other. For example, as shown in FIG. 4, at this point in the rotation of rotor 70, rotor chamber 76 is adjacent to housing chamber 66 to form combustion chamber 106, rotor chamber 77 is adjacent to housing chamber 67 to form combustion chamber 107, rotor chamber 78 is adjacent to housing chamber 68 to form combustion chamber 108, and rotor chamber 79 is adjacent to housing chamber 69 to form combustion chamber 109. During this time, fuel inlets 36-39 operate as fuel injectors and fuel igniters (in the combustion mode) by injecting fuel into combustion chambers 106-109, respectively, and igniting it. The injection of the fuel in combustion chambers 106-109 causes rotor 70 to continue rotating in a counter clockwise direction as seen from drive shaft 28 and as indicated by arrow 99, although rotor 70 can rotate in a clockwise direction in other embodiments.

In this example, rotor 70 rotates in the counter clockwise direction because combustion chambers 106-109 are tilted relative to reference lines 120 and 121 which bisect rotor 70. As best seen in FIG. 4, reference line 120 extends between gas inlets 36 and 38 and through an axis of rotation 75 of rotor 70. Similarly, reference line 121 extends between gas inlets 37 and 39 and through axis of rotation 75 of rotor 70. Axis of rotation 75 extends through the center of rotor 70 in a direction parallel to drive shaft 28. Combustion chambers 106-109 are tilted relative to reference line 120 because combustion chambers 106-109 each have a major axis that is tilted at a non-zero angle θ relative to reference lines 120 or 121. The angle of inclination of combustion chambers 106-109 is an angle most efficient for converting the forces of injected gas propellant or combustion to rotation of rotor 70 in view of the number of chambers employed. In this example, major axes 126 and 128 of combustion chambers 106 and 108, respectively, extend at the angle θ relative to reference line 120. Similarly, major axes 127 and 129 of combustion chambers 107 and 109, respectively, extend at the angle θ relative to reference line 121. Accordingly, rotor chambers 76-79 and housing chambers 66-69 are shaped so that when they are adjacent to each other, rotor 70 rotates in the direction of arrow 99 in response to high pressure gas or combustion within combustion chambers 106-109.

Each rotor chamber 76-79 is sealed from each adjacent rotor chamber as rotor 70 rotates about axis 75. The seal can be provided in many different ways. As shown in FIG. 4, the seal can be provided by positioning a seal ring 74 around the outer periphery of each rotor chamber 76-79. In this way, rotor chambers 76-79 are sealed with housing chambers 66-69 when combustion chambers 106-109 are formed. In this example, each seal ring 74 is carried by rotor 70 so that seal rings 74 are in substantially continuous gas-sealing engagement with inner surface 46 of housing 51 as rotor 70 rotates within and relative to housing 51. Hence, rotor chambers 76-79 cooperate with inner surface 46 of housing 50 and housing chambers 66-69 to effectively define therebetween separate working chambers (i.e. combustion chambers 106-109) separated by sealing members 74.

In other embodiments, as shown in the inset of FIG. 4, the seal can be provided by a seal coating material 73 deposited on inner surface 46 of housing 51 between each adjacent housing chamber 66-69. It should be noted, however, that seal coating material 73 could be positioned on outer surface 72 of rotor 70 between each adjacent rotor chamber 76-79 in other embodiments. Further, a combination of seal coating material 73 and seal rings 74 can be used to isolate each rotor chamber 76-79 from each adjacent rotor chamber and from the exhaust system. It will be understood that the drawings are intended for illustrative purposes only, and the position of the seals will vary depending on the shape of the chambers and like considerations.

The material included in seal coating material 73 can be deposited on surface 46 and/or 72 or it can be material provided by the byproducts of the combustion which occurs in combustion chambers 106-109. During the combustion of the fuel mixture within combustion chambers 106-109, a portion of the combusted mixture can become deposited onto surfaces 46 and/or 72 as rotor 70 rotates. The build-up of this film on surfaces 46 and/or 72 can increase the power output and efficiency of rotary engine 50 because it reduces blow-back between adjacent rotary chambers.

Referring specifically to FIGS. 5A through 5E, a series of steps are illustrated that occur in the power cycle of engine 50 beginning with an initial fuel injection step, generally as illustrated in FIG. 4 and in FIG. 5A. In this step-by-step description of the operation only one combustion chamber 106 is illustrated for simplicity but it will be understood that each of the other combustion chambers 107, 108, and 109 will be in exactly the same positions at each step. Further, it will be understood that the rotation of rotor 7C is continuous and is only depicted in steps to enhance understanding.

In the initial fuel injection step, fuel is injected at a relatively high pressure into combustion chamber 106. Again it should be understood that the “fuel” may be a pressurized pulse of gas propellant in the gas driven mode or a combustible gas in the combustion mode. For simplicity and a better understanding of this description, a combustible gas will be assumed throughout this step-by-step operation. Thus, simply as an example, a pulsed jet of pressurized hydrogen is injected in the step illustrated in FIG. 5A. The pulsed jet of pressurized hydrogen provides a surge of rotary power to rotor 70.

As rotor 70 moves into the position illustrated in FIG. 5B, a pulsed jet of pressurized oxygen is injected into rotor chamber 76 through an inlet 236. The pulsed jet of pressurized hydrogen and the pulsed jet of pressurized oxygen are matched in a well known manner to provide the maximum or complete combustion. Immediately subsequent to the injection of the pulsed jet of pressurized oxygen the fuel in combustion chamber 106 is ignited and expands rapidly in all directions. At this point, because combustion chamber 106 is a closed chamber the pressure from combustion simply expands.

As rotor 70 moves into the position illustrated in FIG. 5C, the expanding gases within combustion chamber 106 come into communication with a high pressure expansion chamber 240. High pressure expansion chamber 240 extends into peripheral inner surface 46 of housing 51 and can have many different shapes, but is generally oblong and extends lengthwise between hemispheres 53 and 54 in this example so that it is substantially perpendicular to flanges 55 and 56. Also, high pressure expansion chamber 240 is substantially closed at the lower end except for a thin slot 242 that extends substantially the length of high pressure expansion chamber 240 and rotor chamber 76 and which allows communication between high pressure expansion chamber 240 and combustion chamber 106. Thin slot 242 allows the expanding high pressure combustion gas in combustion chamber 106 to expand into high pressure expansion chamber 240, which expansion through slot 242 provides power to the rotation of rotor 70. It will be understood that to ensure proper operation of seals (described later), slot 242 and any other slots described may be formed as a line of holes, or the like.

As rotor 70 moves into the position illustrated in FIG. 5D, the expanding gases within combustion chamber 106 come into communication with a low pressure expansion chamber 250. Low pressure expansion chamber 250 extends into peripheral inner surface 46 of housing 51 and can have many different shapes, but is generally oblong and extends lengthwise between hemispheres 53 and 54 in this example so that it is substantially perpendicular to flanges 55 and 56. Also, low pressure expansion chamber 250 is substantially closed at the lower end except for a thin slot 252 that extends substantially the length of low pressure expansion chamber 250 and rotor chamber 76 and which allows communication between low pressure expansion chamber 250 and combustion chamber 106. Thin slot 252 allows the expanding high pressure combustion gas in combustion chamber 106 to expand into low pressure expansion chamber 250, which expansion through slot 252 provides power to the rotation of rotor 70.

A separate high pressure expansion chamber 240 and low pressure expansion chamber 250 are provided in this example to enhance the transfer of power to rotor 70. As is known in the propulsion art (see for example the different sized blades in a turbine), the initial expansion of the high pressure gas is better transferred into rotation by smaller vanes or chambers. However, it will be understood that high pressure expansion chamber 240 and low pressure expansion chamber 250 can be incorporated into a single chamber, either with the combined shape of the two chambers or with a single shape. Also, in a strictly gas driven mode inlet 236 might be eliminated or might be used to provide a second pulse of propellant gas (i.e. after a first pulse from fuel inlet 36) or might be used only to inject a purge gas if the propellant gas is not clean air or the like.

As rotor 70 moves into the position illustrated in FIG. 5E, the expansion of the combustion gases within combustion chamber 106 is complete and the exhaust phase is started. In this step chamber 76 has rotated into communication with exhaust port 86 and removal of the combustion gases begins. It will be noted that at this point chamber 76 is still in communication with inlet 236. Thus, to enhance removal of the combustion gases or to provide a purge step, a pulse of clean air (or other purge gas) can be introduced through inlet 236 at this time. It should also be noticed that high pressure expansion chamber 240 communicates with low pressure expansion chamber 250 through a slot 244 that extends substantially the length of both chambers. Similarly, low pressure expansion chamber 250 communicates with exhaust port 86 through a slot 254 that extends substantially the length of both chamber 76 and exhaust port 86. Thus, the pulse of clean air or other purge gas will clean all of the combustion material from engine 50.

After the exhaust gas is outgassed by the exhaust system, rotor 70 moves so that rotor chambers 76-79 once again face inner surface 46. During this time interval, rotor chamber 76 faces inner surface 46 adjacent housing chamber 67 and exhaust port 86, rotor chamber 77 faces inner surface 46 adjacent housing chamber 68 and exhaust port 87, rotor chamber 78 faces inner surface 46 adjacent housing chamber 69 and exhaust port 88, and rotor chamber 79 faces inner surface 46 adjacent housing chamber 66 and exhaust port 89.

Combustion chamber 106 is formed by housing chamber 66 and rotor chamber 79, combustion chamber 107 is formed by housing chamber 67 and rotor chamber 76, combustion chamber 108 is formed by housing chamber 68 and rotor chamber 77, and combustion chamber 109 is formed by housing chamber 69 and rotor chamber 78. The sequence is then repeated so that fuel system 90 injects fuel into combustion chambers 106-109 through corresponding fuel inlets 36-39. The fuel is then ignited so that rotor 70 keeps rotating. In this way, rotor chambers 76-79 alternate between being adjacent to housing chambers 66-69, surface 46, and exhaust ports 86-89 in a sequential manner to provide combustion, compression, and exhaustion, respectively, so that rotor 70 rotates in response. As rotor 70 keeps rotating, rotor chambers 76-79 eventually face housing chambers 86-89 again to form combustion chambers 106-109.

FIG. 6 is a simplified perspective view of another embodiment of a rotary engine 120 that is similar to rotary engine 50 discussed above. The combustion of the fuel mixture within housing chambers 66-69 and rotor chambers 76-79 can significantly increase the temperature of rotary engine 120 which reduces its efficiency. Accordingly, rotary engine 120 includes a cooling system to reduce its temperature. In accordance with the invention, the cooling system can have many different configurations. In one embodiment, the cooling system includes cooling fins 122 and 124 positioned around the outer periphery of housing 51. Here, cooling fins 122 and 124 are positioned on outer surface 52 of housing 51. Cooling fins 122 and 124 are designed to increase the heat dissipation of rotary engine 120 by increasing the area of surface 52 so that it operates at a lower temperature and, consequently, at a higher efficiency. In other examples, the cooling system can include cooling lines that extend through rotary engine 50 to reduce its temperature. For example, the cooling lines can extend through housing 51 so that the cooling lines flow a coolant, such as water, therethrough housing 51.

FIG. 7 is a simplified side view of another embodiment of an engine system in accordance with the present invention. As discussed above, the number of housing chambers and corresponding rotor chambers determines the amount of power provided by rotary engine 50. If the number of housing and rotor chambers increases, then the power provided by rotary engine 50 also increases. Hence, one way to increase the power provided by engine 50 is to increase the number of housing and rotor chambers included in rotary engine 50. Another way to increase the amount of power provided by engine 50 is to couple a number of them to drive shaft 28. As shown in FIG. 7, three rotary engines 50 are coupled to drive shaft 28. Rotary engines 50 are coupled so that they work together to rotate drive shaft 28 faster than would be possible with fewer rotary engines. Of course, any number of rotary engines can be coupled to drive shaft 28 and the illustration of three rotary engines in FIG. 7 is for illustrative purposes.

The present invention is described above with reference to preferred embodiments. However, those skilled in the art will recognize that changes and modifications may be made in the described embodiments without departing from the nature and scope of the present invention. Various further changes and modifications will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A rotary engine, comprising:
a housing defining an enclosed spherical housing space;
a housing chamber formed in an inner surface of the housing within the spherical housing space;
a spherical rotor rotatably mounted within the spherical housing space;
a rotor chamber formed in an outer surface of the rotor, the housing chamber and the rotor chamber forming a combustion chamber when in communication with each other;
a fuel inlet in communication with the combustion chamber; and
at least one expansion chamber formed in the housing in communication with the enclosed spherical housing space and an exhaust system in communication with the at least one expansion chamber and the enclosed spherical housing space, the at least one expansion chamber and the exhaust system being positioned to come into communication with the combustion chamber during each rotation of the rotor.

2. The engine of claim 1 further including a second inlet positioned to come into communication with the combustion chamber during each rotation of the rotor, the second inlet being designed and positioned to introduce one of a portion of the fuel and a purge gas.

3. The engine of claim 2 wherein the fuel inlet is connected to introduce one of hydrogen gas and oxygen gas and the second inlet is connected to introduce one of oxygen gas and hydrogen gas.

4. The engine of claim 2 wherein the second inlet is connected to introduce clean air as a purge gas.

5. The engine of claim 1 wherein the fuel inlet is designed and positioned to introduce a high pressure pulse of fuel to the combustion chamber and the fuel includes one of a propulsion gas and a combustible gas.

6. The engine of claim 1 wherein a major axis of the combustion chamber is at a non-zero angle relative to a reference line which bisects the rotor.

7. The engine of claim 1 wherein the at least one expansion chamber includes a high pressure expansion chamber and a low pressure expansion chamber.

8. The engine of claim 1 wherein the high pressure expansion chamber is in communication with the combustion chamber through a slot in a wall of the high pressure expansion chamber, and the low pressure expansion chamber is in communication with the combustion chamber through a slot in a wall of the low pressure expansion chamber.

9. The engine of claim 1, further including a seal positioned around the rotor chamber so that the housing chamber and the rotor chamber are sealed together when adjacent to each other.

10. A rotary engine, comprising:
a housing defining an enclosed spherical housing space;
a housing chamber formed in an inner surface of the housing within the spherical housing space;
a spherical rotor positioned within the spherical housing space and rotatably mounted therein, an outer surface of the rotor positioned adjacent the inner surface of the spherical housing space;
a rotor chamber formed in the outer surface of the rotor, the housing chamber and the rotor chamber forming a combustion chamber when in communication with each other;
at least one expansion chamber formed in the housing in communication with the enclosed spherical housing space, the at least one expansion chamber being positioned to come into communication with the combustion chamber during each rotation of the rotor;
a fuel inlet port positioned in communication with the housing chamber and designed and positioned to introduce a pulse of fuel to the combustion chamber;
an exhaust system in communication with the at least one expansion chamber and the enclosed spherical housing space, the exhaust system being positioned to come into communication with the combustion chamber during each rotation of the rotor.

11. The engine of claim 10 further including an ignition system in communication with the housing chamber, the ignition system being connected to ignite combustion gases in the combustion chamber.

12. The engine of claim 11 wherein the at least one expansion chamber is positioned to receive expanding combustion gases subsequent to ignition of the combustion gases in the combustion chamber.

13. The engine of claim 12 wherein the exhaust system is positioned to receive expended combustion gases subsequent to the expansion chamber receiving the expanding combustion gases.

14. The engine of claim 10 further including a second inlet positioned to come into communication with the combustion chamber during each rotation of the rotor, the second inlet being designed and positioned to introduce one of a portion of the fuel and a purge gas.

15. The engine of claim 14 wherein the fuel inlet is connected to introduce one of hydrogen gas and oxygen gas and the second inlet is connected to introduce one of oxygen gas and hydrogen gas.

16. The engine of claim 14 wherein the second inlet is connected to introduce clean air as a purge gas.

17. A rotary engine, comprising:
a housing defining an enclosed spherical housing space;
an arcuate housing chamber formed in an inner surface of the housing within the spherical housing space;
a spherical rotor positioned within the spherical housing space and rotatably mounted therein, an outer surface of the rotor positioned adjacent the inner surface of the spherical housing space;
an arcuate rotor chamber formed in the outer surface of the rotor, the housing chamber and the rotor chamber forming a combustion chamber when in communication with each other;
a fuel inlet port positioned in communication with the housing chamber and designed and positioned to introduce a pulse of combustion gases to the combustion chamber;
an ignition system in communication with the housing chamber, the ignition system being connected to ignite the combustion gases in the combustion chamber subsequent to the introduction of the pulse of combustion gases;
an exhaust system in communication with the at least one expansion chamber and the enclosed spherical housing space, the exhaust system being positioned to come into communication with the combustion chamber during each rotation of the rotor, and the exhaust system being positioned and connected to receive expended combustion gases subsequent to the expansion chamber receiving the expanding combustion gases; and
at least one expansion chamber formed in the housing in communication with the enclosed spherical housing space, the at least one expansion chamber positioned to come into communication with the combustion chamber during each rotation of the rotor, the at least one expansion chamber being further positioned to receive expanding combustion gases from the combustion chamber subsequent to ignition of the combustion gases in the combustion chamber.

18. The engine of claim 17 further including a second inlet positioned to come into communication with the combustion chamber during each rotation of the rotor, the second inlet being designed and positioned to introduce one of a portion of the fuel and a purge gas.

19. The engine of claim 18 wherein the fuel inlet is connected to introduce one of hydrogen gas and oxygen gas and the second inlet is connected to introduce one of oxygen gas and hydrogen gas.

20. The engine of claim 18 wherein the second inlet is connected to introduce clean air as a purge gas.
